(19) United States
(12) Patent Application Publication
(10) Pub. No.: US 2003/0012383 A1
(43) Pub. Date: Jan. 16, 2003

(54) Secure online system using encryption keys bound with an electronic footprint

(76) Inventors: David Bernstein, Seattle, WA (US); Michael W. Pederson, Seattle, WA (US)

Correspondence Address: David Bernstein, 1308 NW 70th Street, Seattle, WA, 98117, US

(21) Appl. No.: 10/184,098

(22) Filed: Jun. 25, 2002

Related U.S. Application Data
(60) Provisional application No. 60/303,485, filed on Jul. 6, 2001.

(51) Int. Cl. H04L 9/00

(52) U.S. Cl. 380/277

(57) ABSTRACT

An electronic footprint that uniquely identifies a computer desktop is used as part of an encryption key to encrypt digital goods, such that the digital goods may only be decrypted on a specific computer. This process is automated using a server containing a decryption service, which itself is encrypted. This system is the basis for an automated licensing system to prevent installation of digital media except on licensed computer desktops, a secure messaging system whose messages can only be decrypted on the computer the message was intended for, and to “harden“ applications such that encrypted applications can run in non-secure environments without the fear of theft or tampering.

### BACKGROUND OF THE INVENTION

Experts agree that billions of dollars are lost to the economy through criminal and casual piracy of software and digital media. Many attempted solutions are in effect, but the losses continue. A dilemma is that after the fact policing and enforcement of licensing of such products is cost prohibitive beyond some rudimentary measures, and effectively impossible without severely encountering erosion of privacy issues. This is exacerbated by the heightened impetus of users in the digital domain to demand both privacy and non-invasive, non-intrusive interactions with digital media suppliers. What is needed is a cost effective before-the-fact digital media security system that is effectively transparent to the user/consumer, and minimally invasive and intrusive upon their privacy and time yet allows the secure, real-time distribution of registration keys

### DISCLOSURE OF THE INVENTION

One way to do this is with electronic distribution of software and digital media by securely delivering encrypted media such that it can only be decrypted on selected, identified and preferably registered licensed desktops. Such a system is also the basis for a secure messaging system whose messages are encrypted in such a way that they may only be decrypted on a specific desktop.

This is advantageously effected by an online decryption service that can generate decryption keys for a specific desktop given the electronic footprint of that desktop. In order for such a critical service to be available online, it is advantageously “hardened” by being encrypted itself, but with the electronic footprint of the machine on which it is registered and running, thereby rendering it unable to be decrypted in the event it is hacked or otherwise stolen and then installed on another computer.

A “licensed desktop” is a licensee's computer whose electronic footprint is registered with the licensor so that a licensed application is encrypted using the licensed desktop's electronic footprint as a decryption/encryption key.

The “electronic footprint” is a unique or nearly enough unique value that is a combination of a selected set of identity information from the target desktop, selected from CPU, chipset and BIOS data, or the like and/or optionally the boot drive. A CRC is applied to the selected combination of these values to generate a single unique number. This electronic footprint can then be used as a transparent and non-intrusive software-only solution that replaces conventional and highly intrusive hardware “dongles” or similar licensing enforcement mechanisms.

An electronic footprint is used in an encryption sequence such that the encrypted application can only be decrypted on a desktop with an “electronic footprint” that matches the one used to generate the decryption key. By requiring the electronic footprint, which then becomes an integral part of the decryption key, which desktops a program may be registered and run on may be strictly controlled.

Since each desktop effectively has a different electronic footprint, this value can be used to encrypt software and other digital media as well as secure messages such that they can only be decrypted on a specific desktop. Such a system can be used to effect licensing policies and prevent the running of software or the use of other licensed digital materials on unlicensed desktops.

Furthermore, such a desktop key based encryption system can also be used as the basis for a secure messaging system where the message's destination electronic footprint can be part of the encrypted message such that the message can only be decrypted at the target desktop for which the message was intended.

Still further, the core of any online decryption service needed to generate decryption keys from hardware footprints is advantageously itself an encrypted application with a encryption key different from any key that it generates. In this way, it is possible to create a secure online key generation service, which is “hardened” because, if hacked and stolen, the service itself would not run on any computer other than the server on which it is registered.

The purpose of this invention is to provide secure desktop delivery of digital media in three important applications: to effect licensing by preventing unauthorized installation of software and data, to be the foundation of a secure communication system where the recipient computer's electronic footprint is part of the decryption key such that a message may only be deciphered when decrypted on the computer the message was encrypted for and for running secure software in non-secure environments by encrypting the software so that its execution is bound to a specific computer.

Digital Desktop Delivery

“Digital desktop delivery” makes use of a client and server program. Portions of the client program are encrypted and/or contain encrypted file(s). The client program is aware of the electronic footprint of the computer, which it is currently running on. The client passes its electronic footprint to the server and requests a decryption key to be used so that only encrypted file(s) on the computer bearing that electronic footprint can be decrypted. The server can keep track of this transaction and restrict issuing registration keys to a selectable number of computers per transaction.

One important aspect of this system is that the code generation program residing on the server itself is encrypted with a different encryption template than the codes it is generating. This is a key feature in making the system truly secure and a preferred way to accomplish the task in a real-time system.

In building such as system the limiting factor in the past was not technology but administration. Because registration codes only decrypt on a specific desktop, we can send that code to the user via email and they can use it to reinstall on the same computer. If a user attempts to register a license on a different desktop than was previously registered, a Web page is preferably displayed giving the user an option to immediately purchase an additional license for the new desktop at a discount.

Not only electronic software distribution but also the licensing terms of any digital media can be effected on a per desktop basis, virtually eliminating the need (and enormous expense) of after-delivery enforcement, or its expensive passive alternative: acquiescence to criminal and casual piracy and rolling the cost into the price structure. The system encrypts conventional executables such as programs, and wraps any selected number of non-executable data files into self-executing, preferably self-extracting deliverable that is then preferably encrypted. Optionally the process is automated so that the inclusion of any file is transparent to the encryption/decryption program, and the digital media does not exist in an unencrypted state except in RAM on the computer it is running on.

Executable programs can be encrypted using off-the-shelf encryption packages that optionally allow the decryption key to take into account the electronic footprint of the computer where the decryption is taking place.

Desktop delivery of secure digital media can be used in any application where one wishes to target digital media to a desktop. One applications is electronic software delivery (ESD) that allows someone to subscribe to or license software on a per desktop basis. Another application is subscription or licensing of any digital media such as music, movies, or the like, to a selected desktop. Any digital media can be encrypted in this way, so long as it is first packed into an executable that can be unpacked directly into memory in its original form once decrypted.

In this system, the program and data files are encrypted with a hardware-bound key so that they may only be decrypted on a specific desktop. By generating keys that are hardware-bound, the unlock codes that we generate for one computer will not work on other computers, allowing us to transparently effect a license arrangement with the user.

When a user attempts to install the software on another desktop than the one it was licensed on, they are optionally given notice to that effect and/or an invitation to purchase an additional license. This system could be used to effect a number of licensing models including multiple desktops per license, a fixed number of reinstalls (to the same desktop), or a subscription model where the application decrypts for a specific amount of time or until a specific date or up to a certain number of uses.

Deploying such a system could potentially cause several logistic problems. These problems are effectively avoided by an automated process adjunct to the system. First, a configurable electronic footprint is generated from data capture from the computer on which the user wishes to install the software. From the unique electronic footprint for the destination computer, a unique registration code is generated. Then, the registration code is entered on the user's system and the program is decrypted. These processes are difficult to do manually and are prone to error.

In our system we have the option of generating registration codes online or offline. When a customer purchases a license to a product, a commerce server notifies an operatively associated database server to generate and send an email to the customer with their transaction ID and instructions on how to register their license.

The user then initiates the registration process in the application by using the registration wizard to enter their user name and transaction ID, among other information. All of this is sent to the server, along with the captured electronic footprint of their system. If the server finds a record with a matching transaction ID that has not already issued a license, it logs the user's electronic footprint and generates their decryption key. If a subsequent request come in for the same transaction ID but different electronic footprint, instead of generating another decryption key for this different desktop, a Web page is displayed to the user informing them that they can purchase additional licenses.

Destination Encryption—Secure Messaging and Communications

“Destination encryption” is simply using a destination desktop's hardware footprint to encrypt messages intended for that destination desktop. In this system, two or more parties exchange hardware footprints and optional passwords. Then the sender encrypts a message using the receiver's hardware footprint. This means that only the receiver's computer can decrypt the message. Such a system may be used to overcome known problems of “spoofing” of Internet addresses to ‘fool’ other destination encryption systems into decrypting a message onto a machine that only appears to be the same machine (same apparent IP address).

Thus messaging and communications in this system are secure because the electronic footprint of any recipient's desktop is encoded in the decryption key so that any message is not only optionally password protected but is decryptable with that password only on a given communication loop using a pre-registered desktop.

Application Hardening

“Application hardening” may prove to be the only way to execute critical applications on public networks securely. This is desirably implemented as a core for an online registration system.

A decryption program that generates registration keys is “hardened” by being encrypted itself to run on only the server it is registered on. This service is preferably implemented in such a way that it will always be encrypted on the hard disk and run decrypted only in RAM on a Web server running in a highly available, multi-threaded environment. Without the encryption templates themselves, which are preferably conventionally physically secured, a “hardened” program can only be decrypted and run on a desktop on which it is registered.

Alternatively, an offline system can be devised for generating registration keys manually while not connected to the Internet.

Encrypting the decryption service becomes a preferred core to a preferred secure online electronic distribution system. Because it is desirable that such a system operate in a high availability environment, it is implemented as an NT service that is conventionally called by an ISAPI DLL. Thus a decrypted version of the key generation program is resident in memory and able to be called from multiple clients with maximum concurrency and minimum delays.

This system is perhaps the only way to achieve a truly secure desktop distribution system for digital media, especially for one that operates in real-time. It applies the fundamental process of data encryption to the application of secure information delivery by leveraging the unique identification markers of the computer the decryption takes place on.

One doesn't have to ponder very long to realize that this is fundamental to enabling many industries in which regulating the exchange of intellectual property on tangible property (i.e. physical networks and desktops) is the central or dominating concern.

Thus in order for any program used to generate decryption codes to exist securely online, it must itself be encrypted with an electronic footprint.

We claim:

1. A method of securing a critical application on a system, the method comprising encrypting the critical application with a decryption program that is itself encrypted to run only on configurable selectable server(s). [This form of software “hardening” allows sensitive and critical applications to be run on public, non-secure systems without fear that it could be stolen and run on another system. The key generation program itself is thus “hardware bound” to the server it is running on.]

2. A system for encrypting any application to run on only one computer so that it is rendered useless if stolen and attempted to install on another computer.

3. A system for transmitting an encrypted message so that it can only be decrypted with an optional specific password and on a selected desktop that is the particular intended desktop destination for the message.

4. A process by which a file may be based on a decryption code that is desktop dependent.

5. A method of securing a critical application on a non-secure network, the method comprising the critical application with an electronic footprint so as it may only be decrypted and run on a specific computer.

6. A real-time licensing system for the secure delivery of encrypted digital goods that automatically generates registration codes from electronic footprints such that the code can be used to decrypt the digital goods on only one computer system.
